(19) United States
(12) Patent Application Publication
(10) Pub. No.: US 2026/0086301 A1
(43) Pub. Date: Mar. 26, 2026

(54) PHOTONIC INTERCONNECTS TO ENABLE COMMUNICATION BETWEEN PROCESSOR COMPONENTS AND MEMORY COMPONENTS

(71) Applicant: Applied Materials, Inc., Santa Clara, CA (US)

(72) Inventors: Ameet S. Bhansali, Pleasanton, CA (US); Omkaram Nalamasu, San Jose, CA (US); Nag B. Patibandla, Pleasanton, CA (US); Robert Blum, Mountain View, CA (US); Wayne McMillan, San Jose, CA (US); Shivkumar Chiruvolu, San Jose, CA (US)

(21) Appl. No.: 19/328,746

(22) Filed: Sep. 15, 2025

Related U.S. Application Data
(60) Provisional application No. 63/697,785, filed on Sep. 23, 2024.

(51) Int. Cl. G02B 6/42; G02B 6/43

(52) U.S. Cl. CPC G02B 6/4214; G02B 6/43

(57) ABSTRACT

A system includes an interposer device including an interposer, and at least a first photonic interconnect and a second photonic interconnect on the interposer. The first photonic interconnect includes at least one turning element within a first dielectric layer, at least one microscopic light-emitting component within a second dielectric layer and above the turning element, and at least one waveguide within the first dielectric layer. The at least one turning element is to direct at least one optical signal generated by the at least one microscopic light-emitting component to the at least one waveguide for transmission to the second photonic interconnect. The system further includes a plurality of components connected to the interposer device. The plurality of components includes a first component connected to the first photonic interconnect and a second component connected to the second photonic interconnect.

### CROSS-REFERENCE TO RELATED APPLICATION(S)

The present application claims the benefit of U.S. Provisional Patent Application No. 63/697,785, filed on Sep. 23, 2024, the entire contents of which are hereby incorporated by reference herein.

### TECHNICAL FIELD

Embodiments of the present disclosure relate to optical devices, and more particularly to photonic interconnects to enable communication between processor components and memory components.

### BACKGROUND

A co-packaged device (e.g., multi-chip module) may include multiple components assembled together. For example, the components may be formed on an interposer, which is an electrical interface that routes connections between the components. An interposer may be used to connect components that may not naturally connect to one another. One example of a component is a processor component (e.g., processor chip). For example, a processor component may include one or more of a graphics processing unit (GPU), a central processing unit (CPU), a data processing unit (DPU), a neural processing unit (NPU), etc. As another example, a processor component may include an application-specific integrated circuit (ASIC). Another example of a component is a memory component (e.g., memory chip). For example, a memory component may be a high bandwidth memory (HBM) component. HBM is a type of computer memory that is designed to provide high bandwidth at lower power consumption, primarily for high-performance compute applications. HBM may achieve these benefits through three-dimensional (3D) stacking technology, where multiple layers of memory chips are vertically stacked and interconnected by through-silicon vias (TSVs). Examples of high-performance computing applications include high-resolution graphics rendering (e.g., using GPU(s)), artificial intelligence (AI), data analytics, and/or machine learning (ML).

### SUMMARY

In some embodiments, a system includes an interposer device including an interposer, and at least a first photonic interconnect and a second photonic interconnect on the interposer. The first photonic interconnect includes at least one turning element within a first dielectric layer, at least one microscopic light-emitting component within a second dielectric layer and above the at least one turning element, and at least one waveguide within the first dielectric layer. The at least one turning element is to direct at least one optical signal generated by the at least one microscopic light-emitting component to the at least one waveguide for transmission to the second photonic interconnect. The system further includes a plurality of components connected to the interposer device. The plurality of components includes a first component connected to the first photonic interconnect and a second component connected to the second photonic interconnect.

In some embodiments, a system includes an interposer device including an interposer, and at least a first photonic interconnect and a second photonic interconnect on the interposer. The first photonic interconnect includes at least one turning element within a first dielectric layer, at least one microscopic light-emitting component within a second dielectric layer and above the at least one turning element, and at least one waveguide within the first dielectric layer. The at least one turning element is to direct at least one optical signal generated by the least one microscopic light-emitting component to the at least one waveguide for transmission to the second photonic interconnect. The system further includes a first set of components on a first side of the interposer device and a second set of components on a second side of the interposer device. The first set of components includes a first component connected to the first photonic interconnect and a second component connected to the second photonic interconnect.

Numerous other aspects and features are provided in accordance with these and other embodiments of the disclosure. Other features and aspects of embodiments of the disclosure will become more fully apparent from the following detailed description, the claims, and the accompanying drawings.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-1B are diagrams of an example system implementing photonic interconnects to enable communication between processor components and memory components, according to some embodiments.

FIG. 2 is a diagram of an example photonic interconnect that may be used to enable communication between a processor component and a memory component, according to some embodiments.

FIGS. 3A-3B are diagrams illustrating example architectures of microscopic light emitting components that may be used within photonic interconnects to enable communication between processor components and memory components, according to some embodiments.

FIG. 4 is a diagram of a top-down view of an example portion of an array of light-emitting components, according to some embodiments.

FIG. 5 is a diagram of a split-open cross-sectional view of an example light-emitting component, according to some embodiments.

FIG. 6 is a diagram of a cross-sectional view of an example light-emitting structure, according to some embodiments.

FIG. 7 is a flowchart of an example method to form an array of microscopic light-emitting components, according to some embodiments.

FIGS. 8-9 are flowcharts of example methods to implement optical devices with undercut-assisted long range evanescent coupling between waveguides, according to some embodiments.

### DETAILED DESCRIPTION

Embodiments of the present disclosure relate to photonic interconnects that may enable communication between processor components (such as processor chips) and memory components (such as memory chips). In conventional computing systems, energy-efficient operation may be limited by the relatively slow data transfer rates of electronic interconnects, which rely on the movement of electrons through conductive materials. Communication of data via electrons may introduce latency and may result in increased power consumption, particularly in high-performance computing applications where large volumes of data are transferred between processors and memory.

Aspects and implementations described herein may address these and other drawbacks by utilizing photonic interconnects to facilitate communication between processor components and memory components. These photonic interconnects may be implemented fort both in-package and on-board communications between component, such as chips mounted on a common substrate or printed circuit board. In some implementations, a system may enable processor components and memory components to exchange data using photons (light particles), instead of electrons. Each component may be connected to a respective photonic interconnect, which may be a unidirectional or bidirectional optical link between adjacent components. In some embodiments, a processor component is connected to a first photonic interconnect, a memory component is connected to a second photonic interconnect, and the first and second photonic interconnects may be used to enable communication of data via photons between the processor component and the memory component. In some embodiments, the processor component includes at least one of a GPU, CPU, a DPU, an NPU, etc. In some embodiments, the memory component is an HBM component.

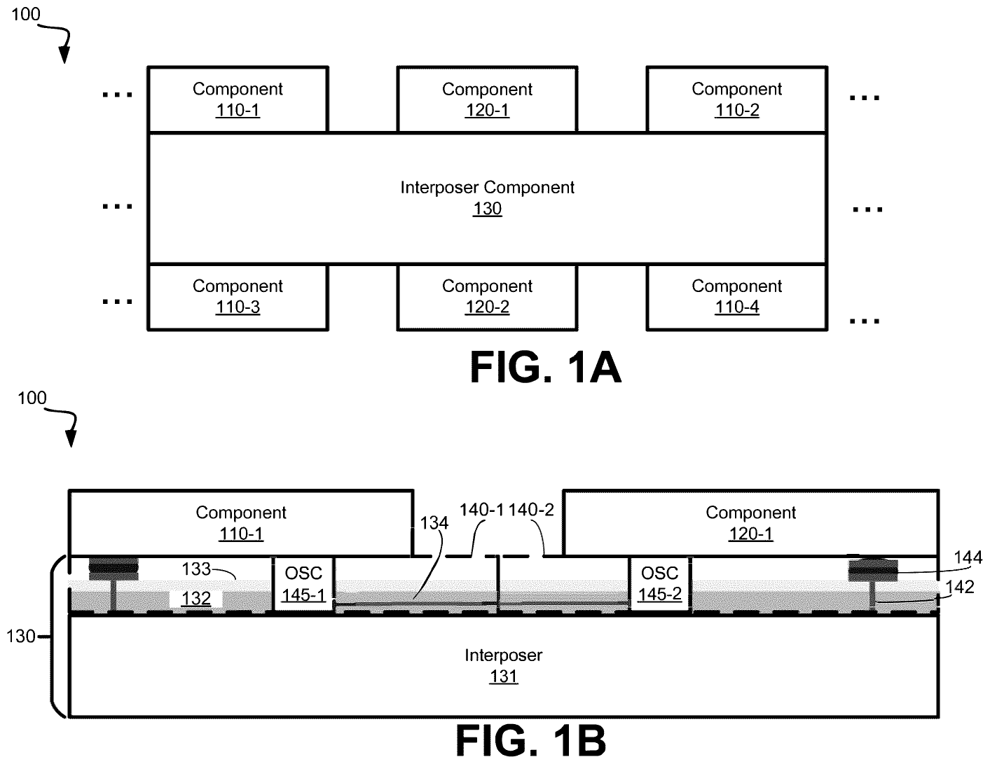

Instead of utilizing external light sources, such as an external laser or light-emitting diode (LED), a photonic interconnect described herein may include an internal light source architecture embedded within the photonic interconnect. More specifically, the internal light source architecture may include an array of microscopic light-emitting components. Each microscopic light-emitting component of the array may be less than or equal to about 100 micrometers (μm) in size (e.g., less than 50 micrometers in size). In some embodiments, the array of microscopic light-emitting devices is an array of microscopic LEDs (microLEDs). For example, an array of microLEDs may include gallium nitride (GaN) based or aluminum-gallium-indium phosphide (AlInGaP) based microLEDs. Some microLEDS described herein (e.g., GaN microLEDs) may be modulated at frequencies between few hundreds of megahertz to few tens of gigahertz to enable data transfer rates as high as ten gigabits per second (Gb/s). The array of microLEDs may be built on active or passive matrix back planes allowing for a precise modulation frequency control of single or a group of microLEDs. In some embodiments, an array of microscopic light-emitting devices is hybrid bonded onto an integrated circuit (IC) used with one or more waveguides to implement massively parallel links with high data rates. For example, the data rates may be greater than or equal to one terabyte per second (Tb/s). In some embodiments, the waveguide of light emitted by the array of microscopic light-emitting devices (e.g., microLEDs) ranges from about 300 nanometers (nm) to about 1000 nm (e.g., about 260 nm to about 430 nm in some embodiments), covering UV-A to visible light spectrum. The photonic interconnect may further include integrated optical modulators, photodetectors, and associated driver and receiver circuitry to enable efficient conversion between electrical and optical signals, as well as to support high-speed data transmission and reception. The use of photonic interconnects as described herein may reduce signal loss, increase bandwidth, and improve energy efficiency relative to conventional electronic interconnects, which may be particularly beneficial in applications such as artificial intelligence, machine learning, and data center computing, where rapid and energy-efficient data movement is implemented. Further details regarding implementing photonic interconnects to enable communication between processor components and memory components are described below with reference to FIGS. 1A-9.

Embodiments described herein may provide numerous other technical advantages. In particular, communication of data between processor and memory components via photons may have various advantages over electron-based data communication. For example, communication of data between processor and memory components via photons may offer higher data rates due to the high-speed performance capabilities of the integrated photonic components such as the optical modulator and photo detector. As another example, photons experience less signal loss as compared to electrons, such that communication of data between processor and memory components via photons may enable more energy-efficient operation as compared to electron-based data communication. Accordingly, embodiments described herein may improve data transfer speeds between processor components and memory components and among multiple memory component architectures.

FIGS. 1A-1B illustrate block diagrams of a system 100, according to some embodiments. As depicted in FIG. 1A, the system 100 may include components 110-1, 110-2, and 120-1 positioned on a first side of an interposer device 130, and components 110-3, 110-4, and 120-2 positioned on a second side of the interposer device 130, opposite the first side. In certain embodiments, components 110-1 through 110-4 are memory components and components 120-1 and 120-2 are processor components. Alternatively, components 110-1 through 110-4 may be processor components, and components 120-1 and 120-2 may be memory components. At least one memory component may be an HBM component. At least one processor component may include a GPU, a CPU, a DPU, an NPU, or other suitable processing architecture. In some embodiments, at least one processor component may include an ASIC. In certain configurations, component 110-1 may be of the same type as component 120-1, such that both are processor components or both are memory components.

At least one pair of photonic interconnects embedded within the interposer device 130 may facilitate or enable communication between at least one respective pair of adjacent components. The interposer device 130 may support many-to-one communication, such as multiple memory components communicating with a processor component, or multiple processor components communicating with a memory component. This architecture may enable high bandwidth, low latency data transfer between components, which may be beneficial for advanced computing systems, such as artificial intelligence accelerators, high-performance computing platforms, or data center applications.

As shown in FIG. 1B, the interposer device 130 may include an interposer 131, a dielectric layer 132 formed on the interposer 131, and a dielectric layer 133 formed on the dielectric layer 132. The dielectric layer 132 may function as a cladding material for optical waveguides. The dielectric layers 132 and 133 may be fabricated from any suitable material, such as oxides, nitrides, oxynitrides, or doped oxides. For example, at least one of the dielectric layers 132 or 133 may be formed from silicon dioxide (SiO₂), which may provide suitable optical and electrical insulation properties. Other materials, such as silicon nitride or aluminum oxide, may also be used depending on the specific requirements for optical confinement and electrical isolation.

The interposer device 130 may further include multiple photonic interconnects, such as photonic interconnect 140-1 connected to component 110-1 and photonic interconnect 140-2 connected to component 120-1, both formed within the dielectric layers 132 and 133. An inner core 134 of at least one waveguide may be formed within the dielectric layer 132, which may serve as the cladding material for the waveguide. This inner core 134 may enable the transmission of light, such as data encoded within an optical signal, between the pair of photonic interconnects 140-1 and 140-2. Materials suitable for forming the inner core 134 may include silicon nitride (Si₃N₄), lithium niobate (LiNbO₃), gallium arsenide (GaAs), indium phosphide (InP), or other materials with appropriate optical properties, such as high refractive index contrast and low optical loss.

In some embodiments, the photonic interconnects 140-1 and 140-2 are fabricated as separate components, or each photonic interconnect is as a separate device. Alternatively, the photonic interconnects 140-1 and 140-2 may be integrated within a single device. Additional photonic interconnects similar to photonic interconnect 140-1 and/or photonic interconnect 140-2 may be connected to other components, such as component 110-2, component 110-3, component 110-4, or component 120-2, to enable scalable and flexible interconnection architectures.

Each photonic interconnect may include a through via 142 extending through the dielectric layers 132 and 133, and a pad 144 formed on the through via 142. The pad 144 may serve as a contact for power and/or ground, or for signal transmission. The through via 142 and the pad 144 may be fabricated from any suitable conductive material, such as copper (Cu), tungsten (W), etc. The use of copper may provide low electrical resistance and high reliability for power delivery and signal integrity.

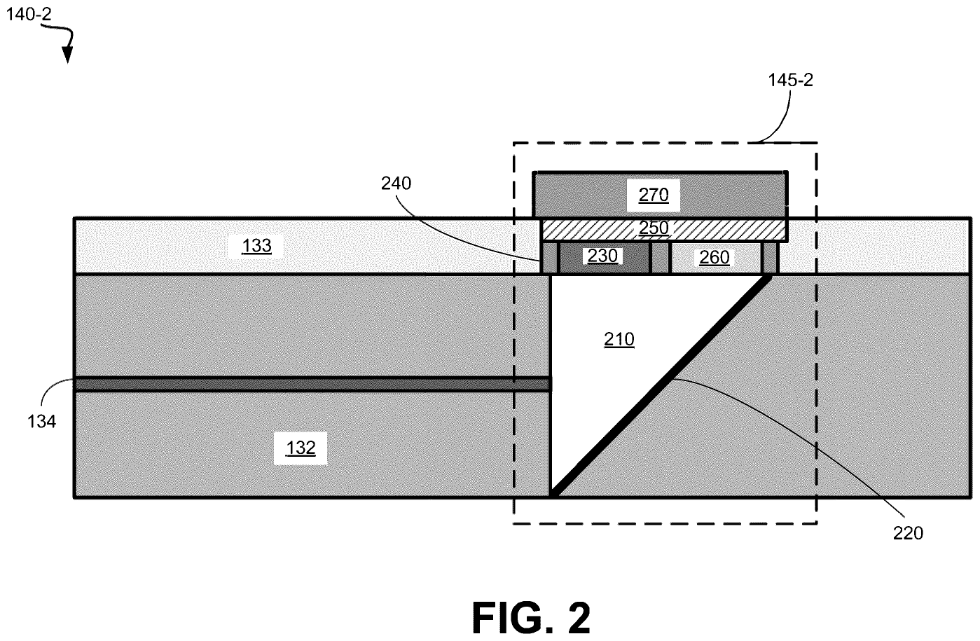

Each photonic interconnect may further include a respective optical signal component (OSC), such as an OSC 145-1 for the photonic interconnect 140-1 and an OSC 145-2 for the photonic interconnect 140-2. Each OSC may incorporate an internal light source architecture, which may include an array of microscopic light-emitting components, such as microLEDs, vertical-cavity surface-emitting lasers (VCSELs), or other suitable light sources. These light sources may be configured to generate optical signals used for data communication between components. The OSCs 145-1 and 145-2 may modulate an optical signal to encode data for transmission to components 120-1 and 110-1, respectively, and may demodulate received optical signals to recover data encoded within the received signals. Modulation techniques may include amplitude modulation, phase modulation, wavelength division multiplexing, etc., and selection of the modulation technique may depend on the system requirements. An example of a photonic interconnect including an OSC is described below with reference to FIG. 2.

FIG. 2 illustrates a cross-sectional view of a portion of an example photonic interconnect 140-2, according to some embodiments. The photonic interconnect 140-1 may be implemented as a mirror image of the photonic interconnect 140-2. For simplicity, the through via 142 and the pad 144 depicted in FIG. 1B are omitted from FIG. 2. As shown in FIG. 2, the photonic interconnect 140-2 may include a segment of dielectric layer 132, a segment of dielectric layer 133, a segment of the inner core 134 that functions as a waveguide within the dielectric layer 132, and the OSC 145-2, as previously described with reference to FIG. 1B.

In some embodiments, the OSC 145-2 includes a trench 210 formed within the dielectric layer 132, and a turning element 220 positioned within the trench 210. The turning element 220 may be any optical component capable of altering the direction of light propagation, such as through reflection or refraction. In certain embodiments, and as shown in FIG. 2, the turning element 220 may be implemented as a mirror. For instance, the trench 210 may have a triangular cross-sectional profile, and the turning element 220 may be an angled mirror formed along a sidewall of the trench 210 that corresponds to the hypotenuse of the triangular cross-section. Alternative turning elements may include prisms, beamsplitters, or gratings, depending on the specific optical routing requirements.

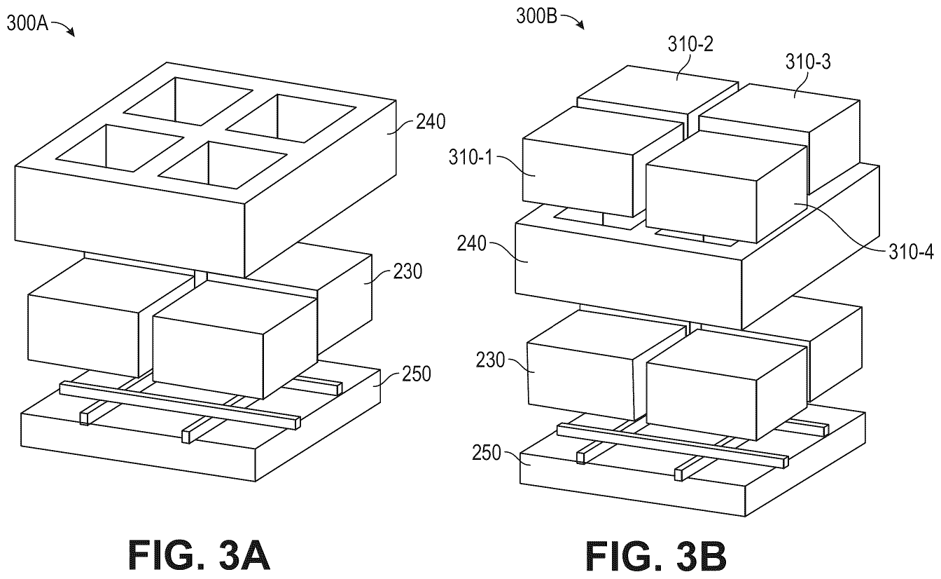

The OSC 145-2 may further include an internal light source architecture, which may incorporate an array of microscopic light-emitting components (“components”) 230. In some embodiments, each component may be a microLED, and each component within array 230 may be referred to as a “pixel” (for example, an LED pixel). Each pixel may be configured to emit light at a specific wavelength, which may include ultraviolet (UV), visible (such as blue, green, or red), or other suitable wavelengths for optical communication. The array 230 may be fabricated with a density greater than or about 1000 components per inch, which may facilitate high-bandwidth optical signaling. Additional details regarding the structure and operation of array 230 will be described below with reference to FIGS. 3A-6.

The internal light source architecture may also include microscopic light-emitting component isolation structures (“isolation structures”) 240. These isolation structures may be implemented as pixel isolation structures, which may serve to prevent optical crosstalk by inhibiting light emitted from one subcomponent from being absorbed by an adjacent subcomponent. This isolation may be achieved through the use of opaque or reflective materials, or by introducing physical barriers between pixels. Further details regarding the isolation structures 240 will be described below with reference to FIGS. 3A-6.

The OSC 145-2 may also include a backplane 250 and a photodetector, such as a photodiode, 260. The backplane 250 may be implemented as a semiconductor substrate, such as silicon or silicon-on-insulator (SOI), and may integrate various circuitry for modulation and demodulation of optical signals. This circuitry may include a light-emitting component driver, a transimpedance amplifier (TIA), multiplexers, demultiplexers, and control logic for managing data flow and synchronization. The light-emitting component driver may modulate the intensity of light emitted by the microscopic light-emitting components of array 230, for example by varying the current supplied to each pixel, which may enable data to be encoded within the optical signal to generate a modulated optical signal. The turning element 220 may direct the modulated optical signal into the inner core 134, which may transmit the modulated optical signal to the photonic interconnect 140-1 for demodulation. In some embodiments, the optical link supports bidirectional communication. At any given time, the array 230 associated with pad 270 (which may be connected to a component such as memory, GPU, CPU, or other integrated circuit) may be active to generate a signal for transmission to another pad associated with a different component, or the photodetector 260 may be active to receive a signal output by an array associated with the other pad. In this way, two or more components may be optically interconnected for high-speed communication.

In some embodiments, the backplane 250 incorporates at least one of power distribution networks, clock distribution circuits, or electrostatic discharge (ESD) protection structures to ensure reliable operation of the optical components. In some embodiments, the backplane 250 supports one or more advanced features such as on-chip memory buffers, error correction logic, and thermal management structures, such as micro-heaters or thermal vias, to maintain optimal performance of the optical link.

Similarly, another photonic interconnect, such as photonic interconnect 140-1 of FIGS. 1A-1B, may transmit a modulated optical signal to the photonic interconnect 140-2 via the inner core 134. The turning element 220 may direct the received modulated optical signal toward the photodetector 260. The photodetector 260 may detect the incoming modulated optical signal and convert the received optical energy into a current proportional to the intensity of the received signal. The TIA may then convert this current into a voltage signal and amplify it to a level suitable for demodulation, which may allow recovery of the data encoded within the received optical signal. As a result, the OSC 145-2 may function as a transceiver, supporting both transmission and reception of optical signals for inter-component communication.

The OSC 145-2 may further include a pad 270 formed on the backplane 250. In some embodiments, the pad 270 serves as an interface for a signal bus, which may facilitate electrical communication between the microscopic light-emitting component architecture and external circuitry. For example, the pad 270 may be configured for a memory signal bus, such as an HBM interface, or for a processor signal bus, such as those used for GPUs or ASICs. The pad 270 may be fabricated from any suitable conductive material, such as copper (Cu), aluminum (Al), or silver (Ag), to ensure low resistance and reliable signal transmission. The pad 270 may be formed using a deposition process, such as sputtering or electroplating, to achieve a target thickness and conductivity. Example operating ranges of parameters for the array 230, such as switching frequency, emission wavelength, and drive current, may be selected based on the intended application and are described herein.

In some embodiments, the microscopic light-emitting component architecture illustrated in FIG. 2 lacks quantum dots. FIG. 3A depicts an example of a microscopic light-emitting component architecture (referred to as architecture 300A) that does not utilize quantum dots. In this example, the architecture 300A may include the array 230, isolation structures 240, and the backplane 250. The array 230 may include four microscopic light-emitting components, such as microLEDs, where each component may be configured to emit light at a specific wavelength. The isolation structures 240 may electrically and optically isolate each microscopic light-emitting component to minimize crosstalk and improve color purity. The backplane 250 may provide mechanical support and may include circuitry for driving and controlling the individual light-emitting components.

In some embodiments, the microscopic light-emitting component architecture of FIG. 2 includes quantum dots. FIG. 3B illustrates an example of a microscopic light-emitting component architecture 300B that is similar to architecture 300A, but further includes quantum dots 310-1 through 310-4. The quantum dots 310-1 through 310-4 may be positioned to absorb light of a first wavelength emitted by the array 230 and may re-emit light at a second, longer wavelength. The use of the quantum dots 310-1 through 310-4 may enable precise tuning of the emission spectrum, which may be beneficial for applications requiring high color accuracy or wide color gamut. The quantum dots 310-1 through 310-4 may be deposited using techniques such as inkjet printing, spin coating, or photolithography, and may be encapsulated to enhance stability and prevent degradation due to environmental exposure.

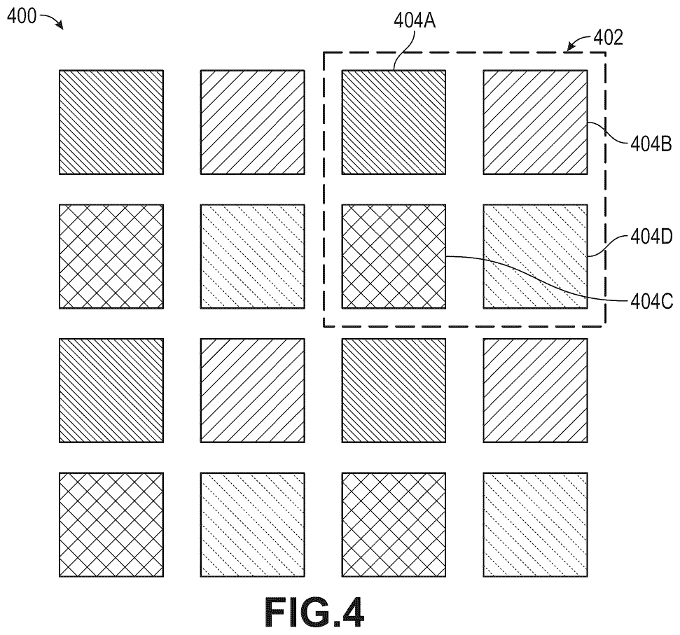

FIG. 4 illustrates a top-down view of an example portion of an array of light-emitting components (“array”) 400, according to some embodiments. The array 400 may be similar to the array 230 described above with reference to FIGS. 3-4B.

As depicted in FIG. 4, the array 400 may include four microscopic light-emitting components (“components”) 402, each of which may include four subcomponents 404A-D. In some embodiments, a component may be implemented as an LED. For example, a component may function as a pixel (e.g., an LED pixel), and a subcomponent may function as a subpixel. The three subcomponents 404A-C may be operable to emit visible light at different peak wavelengths, while the subcomponent 404D may serve as a replacement or redundant element in the event that any of the other three subcomponents 404A-C experience failure during the fabrication process of the high-pixel-density structure. In some embodiments, the three subcomponents 404A-C may be configured to emit visible light in the red, green, and blue regions of the electromagnetic spectrum, respectively. The emission of these primary colors may enable the generation of a wide range of colors through additive color mixing. In some embodiments, the longest dimension of each of the subcomponents 404A-C may be less than or equal to about 100 μm.

In some embodiments, subcomponent 404A is a red subcomponent operable to emit visible light characterized by a peak intensity wavelength of greater than or about 580 nm, greater than or about 585 nm, greater than or about 590 nm, greater than or about 595 nm, greater than or about 600 nm, greater than or about 605 nm, greater than or about 610 nm, greater than or about 615 nm, greater than or about 620 nm, or more. The emission wavelength may be selected based on the specific color requirements.

In some embodiments, subcomponent 404B is a green subcomponent operable to emit visible light characterized by a peak intensity wavelength between 500 nm and 580 nm. The green emission may be tuned by adjusting the material composition or quantum well structure of the subcomponent.

In some embodiments, subcomponent 404C is a blue subcomponent operable to emit visible light characterized by a peak intensity wavelength less than or about 500 nm, less than or about 490 nm, less than or about 480 nm, less than or about 470 nm, less than or about 460 nm, less than or about 450 nm, less than or about 440 nm, less than or about 430 nm, less than or about 420 nm, less than or about 410 nm, less than or about 400 nm, or less. The blue emission may be achieved using materials such as InGaN or other suitable semiconductor compounds.

In some embodiments, the light emitted from the subcomponents 404A-C may be characterized by a spectral bandwidth of less than or about 100 nm, less than or about 90 nm, less than or about 80 nm, less than or about 70 nm, less than or about 60 nm, less than or about 50 nm, less than or about 40 nm, less than or about 30 nm, less than or about 20 nm, or less.

In some embodiments, and as shown in FIG. 4, the components 402 may be arranged in a square-shaped configuration of four square-shaped subcomponents 404-D. It should be understood that the subcomponents 404A-D may be fabricated in a variety of shapes, including but not limited to rectangular, parallelogram, trapezoidal, pentagonal, hexagonal, heptagonal, octagonal, nonagonal, circular, and elliptical shapes, depending on the design and manufacturing requirements. Similarly, the components 402 may be arranged in additional configurations, such as rectangular, parallelogram, trapezoidal, circular, and elliptical configurations, among other possible shapes. In further embodiments, each of the subcomponents 404A-D may be characterized by a longest dimension (for example, a diagonal length) that is less than or about 10 μm, less than or about 9 μm, less than or about 8 μm, less than or about 7 μm, less than or about 6 μm, less than or about 5 μm, or less. This miniaturization may be achieved through advanced lithography and etching techniques, which may achieve ultra-high pixel densities. In additional embodiments, each of the pixels 202 may be characterized by a longest dimension of less than or about 25 μm, less than or about 22.5 μm, less than or about 20 μm, less than or about 17.5 μm, less than or about 15 μm, less than or about 12.5 μm, less than or about 10 μm, or less.

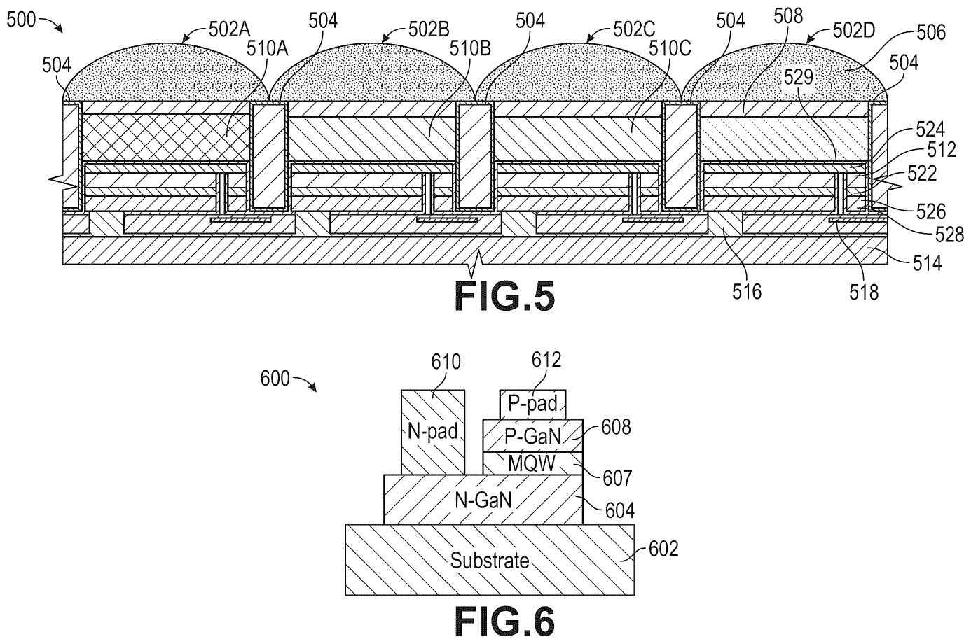

FIG. 5 is a diagram of a split-open cross-sectional view of an example light-emitting component (“component”) 500, according to some embodiments. The component 500 corresponds to the component 402 of FIG. 5 (e.g., a pixel). As shown in FIG. 5, a light-emitting component, like the light-emitting components 402 shown in FIG. 4, is cut between subcomponents 404A-B and 404C-D and split open to reveal a cross-sectional liner arrangement of red, green, blue, and blank subcomponents (e.g., subpixels) 502A-D.

The subcomponents 502A-D may be isolated from each other by isolation structures 504 between adjacent subcomponents. In some embodiments, one or more of the subcomponents 502A-D includes a microlens 506 positioned on a UV barrier layer 508. In some embodiments, each of the subcomponents 502A-C includes a respective one of quantum dots 510A-C, where each of the quantum dots 510A-C is operable to emit different peak intensity wavelengths of visible light (e.g., red, green, and blue light). A fourth subcomponent 502D may include a matrix material that does not include a quantum dot, unless it functions as a replacement subcomponent for one of the other subcomponents 502A-C.

The subcomponents 502A-D may include light-emitting structures (“structures”) 512 operable to generate short-wavelength light that pumps a quantum-dot-layer 510A-C to emit longer-wavelength, visible light. For example, the structures 512 may include LED structures. In some embodiments, the structures 512 are independently activated by a backplane 514. In some embodiments, the backplane 514 includes a set of first contacts 516 and second contacts 518 formed in a semiconductor layer that independently address the structures 512. In some embodiments, the contacts 516 and 518 are formed from an electrically conductive material such as copper, aluminum, gold, tungsten, chromium, or nickel, among other electrically conductive materials. In still some embodiments, the structures 512 may be positioned between transparent electrically conductive layers 522 and 524 that form part of the electrical conduction pathway between the structures 512 and the contacts 516 and 518 in the backplane 514. In some embodiments, the transparent conductive layers may be made of indium tin oxide or indium zinc oxide, among other transparent conductive materials. In some embodiments, a mirror layer 526 is positioned adjacent to the transparent electrically conductive layer 524 to reflect light emitted by a light-emitting structure towards a quantum dot. In some embodiments, the mirror layer 526 may be made of one or more reflective metals such as copper, aluminum, chromium, silver, platinum, or molybdenum, among other reflective metals. In some embodiments, an electrically bonding layer 528 that bonds the light-emitting component substrate to the backplane 514 is positioned between the mirror layer 526 and the backplane 514. In some embodiments, the bonding layer is an electrically conductive bonding layer formed from one or more conductive materials such as tin, gold, or indium, among other conductive materials.

In some embodiments, a passivation layer 529 is positioned around the structures 512 and adjacent electrically conductive layers (e.g., transparent electrically conductive layers 522 and 524, mirror layer 526, and bonding layer 528). The passivation layer 529 electrically isolates the structures 512 from other conductive materials in the subcomponents 502A-D so that only the first and second contacts 516 and 518 may electrically switch on and off the structures 512. In some embodiments, the passivation layer 529 is made of a dielectric material such as silicon oxide, silicon nitride, aluminum oxide, or aluminum nitride, among other dielectric materials. In some embodiments, the subcomponents 502A-D may be independently switched on and off by sending electrical signals through the first contacts 516 and second contacts 518. The electrical signals may pass through the contacts and other electrically conductive layers such as bonding layer 528, mirror layer 526, and transparent electrically conductive layers 522 and 524 to activate the structures 512 and cause them to emit light.

In some embodiments, the wavelength of light emitted by the structures 512 is shorter (e.g., more energetic) than the wavelengths emitted by any of the quantum dots 510A-C. In some embodiments, the structures 512 may be operable to emit light characterized by a peak intensity wavelength of less than or about 400 nm, less than or about 395 nm, less than or about 390 nm, less than or about 385 nm, less than or about 380 nm, less than or about 375 nm, less than or about 270 nm, less than or about 365 nm, less than or about 260 nm, less than or about 355 nm, less than or about 250 nm, or less. In still some embodiments, the structures 512 may emit the same or different peak intensity wavelengths of ultraviolet light.

FIG. 6 is a diagram of a cross-sectional view of an example light-emitting structure (“structure”) 600, according to some embodiments. The structure 600 may correspond to one of the structures 512 of FIG. 5. In some embodiments, and as shown in FIG. 6, the structure 600 is a gallium-and-nitrogen-containing light-emitting structure (e.g., GaN light emitting structure). However, such embodiments should not be considered limiting.

As shown in FIG. 6, the structure 600 may be epitaxially formed on a substrate 602. The substrate 602 may include any suitable material. In some embodiments, the substrate 602 is a silicon substrate. In some embodiments, the substrate 602 is a sapphire substrate. The structure 600 may further include an n-doped GaN layer 604 and a p-doped GaN layer 608. Formed between the n-doped GaN layer 604 and the p-doped GaN layer 608 is a multiple-quantum-well (MQW) region 606 where the light emitted by the structure 600 is generated. The structure 600 may further include an N-pad contact 610 that forms a pathway for electrical current to pass through the n-doped GaN layer 604. The structure 600 may also include a P-pad contact 612 that forms a pathway for electrical current to pass through the p-doped GaN layer 608. The N-pad contact 610 and the P-pad contact 612 may be connected to electrically conducive layers in a subcomponent or directly connected to contacts in the control circuitry of a backplane. In some embodiments, electrical signals from the control circuitry create a flow of electrical current through the structure 600 that causes light emission from the MQW region 606 of the structure 600. In some embodiments, the MQW region 606 is formed to emit light characterized by a repeatable peak intensity wavelength and quantum efficiency for an applied electrical signal (e.g., electrical current and/or voltage). In some embodiments, the peak intensity wavelength of the light emitted from the MQW region 606 may be UV wavelength.

The structure 600 is shown fully formed on substrate 602. In some embodiments, the substrate 602 is removed. In some of these embodiments, the component and the backplane are bonded together before the formation of discrete light-emitting structures including the structure 600. In some embodiments, the substrate 602 is separated from the layers of component materials bonded together with the backplane before the layers of component materials are formed into the light-emitting structures including the structure 600.

Referring back to FIG. 5, the short-wavelength light emitted by the structures 512 may energize the quantum dots 510A-C and cause them to emit light of longer wavelengths. As noted above, each of the quantum dots 510A-C is operable to absorb light from a respective one of the structures 512 and emit light in a different part of the electromagnetic spectrum. In some embodiments, the quantum dot 510A is operable to emit light in the red portion of the spectrum, the quantum dot 510B is operable to emit light in the green portion of the spectrum, and the quantum dot 510C is operable to emit light in the blue portion of the spectrum. The light generated by quantum dots 510A-C and the structures 512 pass through UV barrier layer 508 that absorbs UV generated by the structures 512 while passing the visible light from the quantum dots 510A-C. In some embodiments, the light passing through the UV barrier layer 508 is focused by the microlens 506.

In some embodiments, the structures 512 may emit light characterized by the same or nearly the same peak intensity wavelength. These embodiments address a problem with some types of structures 512 (e.g., gallium-and-nitrogen-containing structures) having different quantum efficiencies for light emissions at different peak intensity wavelengths. These differences are particularly pronounced between such structures 512 that emit red and blue visible light. These structures 512 may have greater quantum efficiencies for the emission of the blue light than the red light, and in many cases, additional structures and operational techniques are required to compensate. In some embodiments, the structures 512 are formed to emit light of the same or nearly the same peak intensity wavelength and may be selected to emit light at a wavelength that has a high quantum efficiency for the gallium-and-nitrogen-containing LED structures. In some embodiments, the peak intensity wavelength may be an UV wavelength that may be absorbed by the quantum dots 510A-C to cause the quantum dots 510A-C to emit light at visible wavelengths. In contrast to the structures 512 that may have a wide variation in the quantum efficiency of light emitted between the blue and red portions of the visible spectrum, the quantum dots quantum dots 510A-C may have a narrower variation in the quantum efficiency for light absorbed at an UV wavelength to cause emission at different wavelengths of the visible spectrum.

In some embodiments, the variation in the quantum efficiency of visible light emitted from quantum dots 510A-C may be less than or about 25%, less than or about 15%, less than or about 10%, less than or about 5%, less than or about 2.5%, less than or about 1%, or less. In some embodiments, the quantum dots may be characterized by quantum efficiencies of greater than or about 50%, greater than or about 60%, greater than or about 70%, greater than or about 80%, greater than or about 90%, greater than or about 95%, greater than or about 97%, greater than or about 98%, greater than or about 99%, or more.

In some embodiments, crosstalk created by light generated from adjacent and nearby subcomponents may be reduced or eliminated by the isolation structures 504 between adjacent components. In some embodiments, the reduction in the intensity of light from adjacent and nearby components may be greater than or about 50%, greater than or about 60%, greater than or about 70%, greater than or about 80%, greater than or about 90%, greater than or about 95%, greater than or about 99%, or more. In some embodiments, the isolation structures 504 include a core column of pixel isolation material that is covered by one or more additional layers of material, such as a layer of reflective material such as aluminum or copper. In some embodiments, the material in the core column may include a metal or a dielectric material, among other types of materials. In some embodiments, the metal material includes one or more of silicon, tungsten, copper, and aluminum, among other metals. In some embodiments, the dielectric material includes one or more of silicon oxide, silicon nitride, silicon carbide, a photoresist material, or a dielectric organic-polymer material, among other dielectric materials.

In some embodiments, the isolation structures 504 extend from the backplane 514 to a top surface of the quantum-dot-layers 510A-C. In some embodiments, the isolation structures 504 extend to the UV barrier layer 508. In some embodiments, the isolation structures 504 extend to the apex of each microlens 506. In some embodiments, the isolation structures 504 have a height of greater than or about 2.5 μm, greater than or about 5 μm, greater than or about 7.5 μm, greater than or about 10 μm, greater than or about 12.5 μm, greater than or about 15 μm, greater than or about 17.5 μm, greater than or about 20 μm, or more. In some embodiments, the pixel isolation structures 304 may have a width of greater than or about 1 μm, greater than or about 2 μm, greater than or about 3 μm, greater than or about 4 μm, greater than or about 5 μm, greater than or about 6 μm, greater than or about 7 μm, greater than or about 8 μm, greater than or about 9 μm, greater than or about 10 μm, or more. In still some embodiments the pixel isolation structures 304 may have a height-to-width aspect ratio that is greater than or about 1.5:1, greater than or about 2:1, greater than or about 2.5:1, greater than or about 3:1, greater than or about 3.5:1, greater than or about 4:1, greater than or about 4.5:1, greater than or about 5:1, or more.

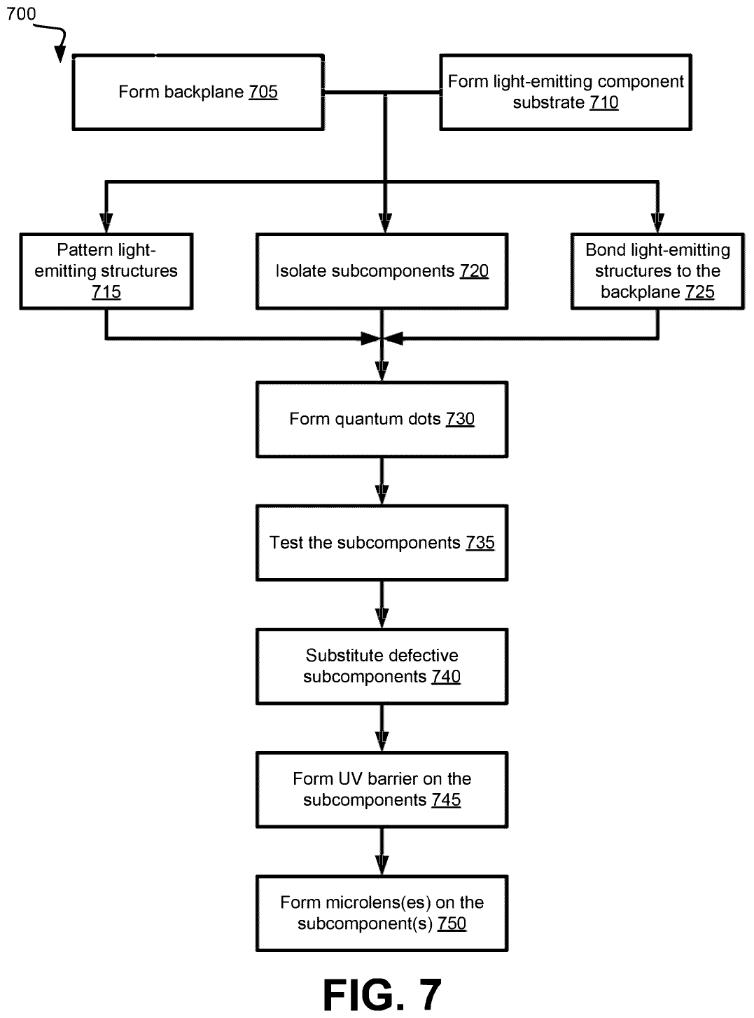

FIG. 7 is a flowchart of a method 700 to form an array of microscopic light-emitting components (“array”), according to some embodiments. For example, the array may be similar to the array 230 of FIGS. 2-3B and/or the array 400 of FIG. 4. Method 700 may or may not include one or more operations prior to the initiation of the method, including front-end processing, deposition, etching, polishing, cleaning, or any other operations that may be performed prior to the described operations. The method may include a number of optional operations, which may or may not be specifically associated with some embodiments.

At block 705, a backplane is formed and at block 710, a light-emitting component substrate is formed. In some embodiments, the backplane includes a backplane layer that includes at least a portion of the control circuitry for activating subcomponents in each components. In some embodiments, the backplane includes a silicon substrate in which elements of the control circuitry are formed, including contacts to form electrically conductive pathways through the interface between the backplane and the light-emitting component substrate.

At block 715, light-emitting structures (“structures”) are patterned on a substrate. At block 720, subcomponents are isolated. At block 725, the backplane is bonded to the light-emitting component substrate. Blocks 715, 720 and 725 may be performed in any suitable order.

At block 730, quantum dots are formed in the isolated subcomponents. In some embodiments, the formation of the quantum dots includes sequential operations to form a quantum dot operable to emit light characterized by a particular peak intensity wavelength in one of the subcomponents of each component of the array. In some embodiments, the sequential operations include forming a red quantum dot in a first subcomponent of a component, forming a green quantum dot in a second subcomponent of the component, and then forming a blue quantum dot in a third subcomponent of the component. Accordingly, in some embodiments, a component of the array may include red, green, and blue subcomponents.

In some embodiments, the formation of a quantum dot operable to emit a particular color of visible light (e.g., red, green, or blue light) in a subcomponent includes, for each component of the array, dispensing a photo-curable fluid over the subcomponents of the component, activating at least one subcomponent of the plurality of subcomponents to illuminate and cure the photo-curable fluid over the at least one subcomponent, and removing uncured photo-curable fluid from any subcomponents that were not activated. These formation operations may be repeated for the subcomponents emitting each color of light in the array. In some embodiments, the formation operation self-aligns the quantum dots with the activated subcomponents throughout the array. No precision alignment operations are required to form the quantum dots in the proper group of subcomponents. The self-alignment of the quantum dots may be increasingly beneficial as the size of the subcomponents decreases and the component density increases.

In some embodiments, the photo-curable fluid includes one or more cross-linkable compounds, a photo-initiator, and a color conversion agent. In some embodiments, the cross-linkable compounds include monomers that form a polymer when cured. In some embodiments, the monomers include acrylate monomers, methacrylate monomers, and acrylamide monomers. In some embodiments, the cross-linkable compounds include a negative photoresist material such as SU-8 photoresist. In some embodiments, the photo-initiator includes phosphine oxide compounds and keto compounds, among other kinds of photo-initiator compounds that generate radicals that initiate the curing of unsaturated compounds when excited by ultraviolet light. Commercially available photo-initiator compounds include Irgacure 184, Irgacure 819, Darocur 1173, Darocur 4265, Darocur TPO, Omnicat 250, and Omnicat 550, among other photo-initiators. In some embodiments, the color conversion agent includes a quantum dot material that may absorb shorter wavelength (i.e., more energetic) light from an LED structure and emit longer wavelength light corresponding to the color of light emitted by the subcomponent. In some embodiments, these quantum dot materials include nanoparticles made of one or more kinds of inorganic semiconductor materials such as indium phosphide, zinc selenide, zinc sulfide, silicon, silicates, and graphene, and doped inorganic oxides, among other semiconductor materials.

At block 735, the subcomponents of at least one component are tested. In some embodiments, the subcomponents are tested after the formation of each color of the quantum dots. In some embodiments, the subcomponents are tested after forming each of the quantum dots. In some embodiments, the testing operation may include activating all the subcomponents and detecting which subcomponents are defective. In some embodiments, these defects include subcomponents that fail to generate any light, subcomponents that fail to generate light at a constant intensity, and subcomponents that fail to generate light at a target intensity (e.g., subcomponents that are too dim or too bright), among other kinds of defects.

At block 740, any defective subcomponents of the at least one component are substituted. In some embodiments, the substitution includes forming a replacement quantum dot in a subcomponent of the at least one component that does not include a quantum dot (e.g., a blank subcomponent). The replacement quantum dot is operable to emit light at the same wavelength as the defective subcomponent that will be deactivated. The substitution may reduce the number of faulty components of the array.

At block 745, a UV barrier layer may be performed on the subcomponents. In some embodiments, the UV barrier layer is formed over the quantum dots in the subcomponents that include quantum dots, and over the light-emitting structures of the subcomponents that lack quantum dots. In some embodiments, the UV barrier layer is a dielectric layer that absorbs UV light generated by the light-emitting structure in a subcomponent while transmitting the visible light emitted by a quantum dot. In some embodiments, the dielectric layer is a silicon oxide layer deposited by chemical vapor deposition or physical vapor deposition. In some embodiments, the UV barrier layer is made from organic polymers such as polyacrylates, polymethyl methacrylates, and copolymers of polyacrylates and polymethyl methacrylates. In some embodiments, the UV barrier layer reduces the percentage of UV light in the total light emitted to less than or about 5%, less than or about 2.5%, less than or about 1%, less than or about 0.5%, less than or about 0.1%, less than or about 0.05%, less than or about 0.01%, or less. In some embodiments, the UV barrier layer transmits visible light from the quantum dot at greater than or about 50%, greater than or about 75%, greater than or about 85%, greater than or about 90%, greater than or about 95%, greater than or about 99%, or more.

At block 750, one or more microlenses are formed on one or more of the subcomponents. In some embodiments, a microlens is formed on each subcomponent of a plurality of subcomponents. In some embodiments, a microlens is formed on all of the subcomponents. In some embodiments, a microlens is a convex-shaped lenses, a concave-shaped lens, a Fresnel-shaped lenses, or other lens shapes. In some embodiments, a microlens is formed from a material (organic or inorganic) that may transmit the visible light emitted from the subcomponents. In some embodiments, a microlens is made of a polymer such as polydimethylsiloxanes, polyacrylates, polymethyl methacrylates, polybutyl methacrylates, polystyrenes, and poly(benzyl methacrylates), among other polymers. In some embodiments, a microlens is formed from inorganic materials such as silica, zinc oxide, and aluminum oxide, among other inorganic materials.

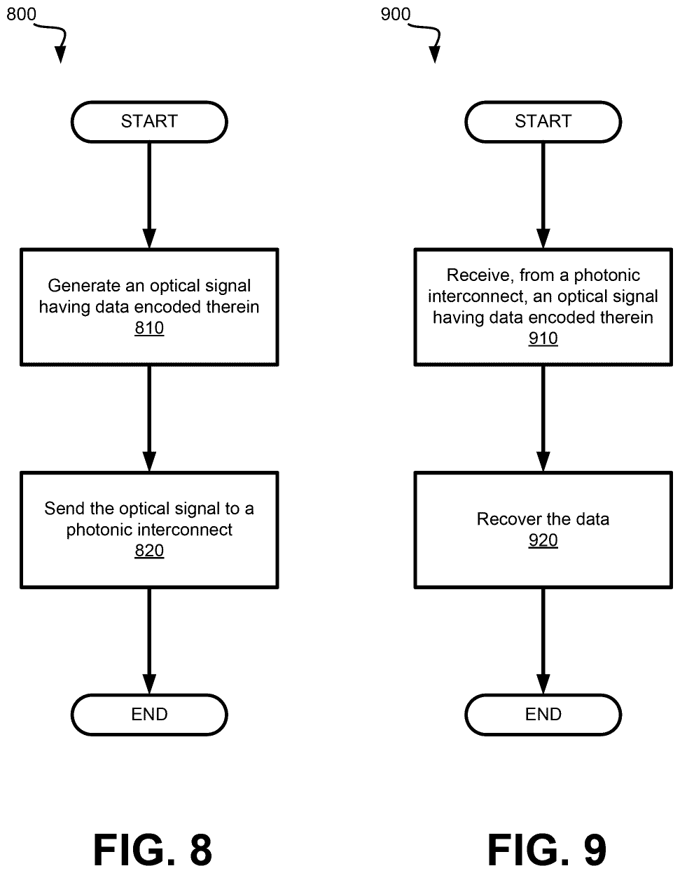

FIG. 8 is a flowchart of a method 800 to implement a photonic interconnect, according to some embodiments. The photonic interconnect may be connected to a component (e.g., a processor component or a memory component). For example, the photonic interconnect may be similar the photonic interconnect 140-1 connected to the component 110-1 or the photonic interconnected 140-2 connected to the component 120-1, as described above with reference to FIGS. 1B-4.

At block 810, an optical signal having data encoded therein is generated. For example, the optical signal may be generated by an array of microscopic light-emitting components. In some embodiments, the array of microscopic light-emitting components includes an array of microLEDs.

At block 820, the optical signal is sent to a photonic interconnect. More specifically, the photonic interconnect may be connected to another component (e.g., a memory component or a processor component). The photonic interconnect may demodulate the optical signal to recover the data. Further details regarding blocks 810-820 are described above with reference to FIGS. 1A-7.

FIG. 9 is a flowchart of a method 900 to implement a photonic interconnect, according to some embodiments. The photonic interconnect may be connected to a component (e.g., a processor component or a memory component). For example, the photonic interconnect may be similar the photonic interconnect 140-1 connected to the component 110-1 or the photonic interconnected 140-2 connected to the component 120-1, as described above with reference to FIGS. 1B-5.

At block 910, an optical signal having data encoded therein is received. For example, the optical signal may be received from another photonic interconnect connected to another component (e.g., a memory component or a processor component). The optical signal may be generated by an array of microscopic light-emitting components of the other photonic interconnect. In some embodiments, the array of microscopic light-emitting components includes an array of microLEDs. For example, a modulation component (e.g. light-emitting component driver) may cause the array to generate the optical signal.

At block 920, the data is recovered. More specifically, the data may be recovered by demodulating the optical signal. For example, a photodetector may convert the optical signal into a current, and a demodulation component (e.g., TIA) may convert the current into a voltage signal for recovering the data. Further details regarding blocks 910-920 are described above with reference to FIGS. 1A-8.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within +10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In some embodiments, the term “at least about” includes the recited number minus 10% and any quantity that is higher such that “at least about 10” would include 9 and anything greater than 9. This term may also be expressed as “about 10 or more.” Similarly, the term “less than about” typically includes the recited number plus 10% and any quantity that is lower such that “less than about 10” would include 11 and anything less than 11. This term may also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
an interposer device comprising:
an interposer;
at least a first photonic interconnect and a second photonic interconnect on the interposer, wherein at least the first photonic interconnect comprises:
at least one turning element within a first dielectric layer;
at least one microscopic light-emitting component within a second dielectric layer and above the at least one turning element; and
at least one waveguide within the first dielectric layer, wherein the at least one turning element is to direct at least one optical signal generated by the at least one microscopic light-emitting component to the at least one waveguide for transmission to the second photonic interconnect; and
a plurality of components connected to the interposer device, wherein the plurality of components comprises a first component connected to the first photonic interconnect and a second component connected to the second photonic interconnect.

2. The system of claim 1, wherein the at least one microscopic light-emitting component comprises at least one microscopic light-emitting diode (microLED).

3. The system of claim 1, wherein the first photonic interconnect further comprises a modulation and demodulation component to:
modulate an optical signal to encode data within the optical signal; and
demodulate a received optical signal to recover data encoded in the received optical signal.

4. The system of claim 3, wherein the first photonic interconnect comprises a photodetector to convert the received optical signal into a current having a magnitude proportional to an intensity of the received optical signal.

5. The system of claim 1, wherein the at least one microscopic light-emitting component comprises a plurality of subcomponents, and wherein at least one subcomponent of the plurality of subcomponents comprises a light-emitting structure to output a respective wavelength of light.

6. The system of claim 5, wherein the at least one microscopic light-emitting component corresponds to a pixel, and wherein each subcomponent of the plurality of subcomponents corresponds to a subpixel.

7. The system of claim 1, wherein the at least one microscopic light-emitting component further comprises at least one quantum dot.

8. The system of claim 7, wherein the at least one microscopic light-emitting component comprises a plurality of subcomponents, and wherein the at least one quantum dot is on at least one subcomponent of the plurality of subcomponents.

9. The system of claim 1, wherein the first component is a processor component, and wherein the second component is a memory component.

10. The system of claim 9, wherein the second component is a high bandwidth memory (HBM) component.

11. A system comprising:
an interposer device comprising:
an interposer;
at least a first photonic interconnect and a second photonic interconnect on the interposer, wherein at least the first photonic interconnect of comprises:
at least one turning element within a first dielectric layer;
at least one microscopic light-emitting component within a second dielectric layer and above the at least one turning element; and
at least one waveguide within the first dielectric layer, wherein the at least one turning element is to direct at least one optical signal generated by the at least one microscopic light-emitting component to the at least one waveguide for transmission to the second photonic interconnect;
a first set of components on a first side of the interposer device, wherein the first set of components comprises a first component connected to the first photonic interconnect and a second component connected to the second photonic interconnect; and
a second set of components on a second side of the interposer device.

12. The system of claim 11, wherein the at least one microscopic light-emitting component comprises at least one microscopic light-emitting diode (microLED).

13. The system of claim 11, wherein the first photonic interconnect further comprises a modulation and demodulation component to:
modulate an optical signal to encode data within the optical signal; and
demodulate a received optical signal to recover data encoded in the received optical signal.

14. The system of claim 13, wherein the first photonic interconnect comprises a photodetector to convert the received optical signal into a current having a magnitude proportional to an intensity of the received optical signal.

15. The system of claim 11, wherein the least one microscopic light-emitting component comprises a plurality of subcomponents, and wherein at least one subcomponent of the plurality of subcomponents comprises a light-emitting structure to output a respective wavelength of light.

16. The system of claim 15, wherein the least one microscopic light-emitting component corresponds to a pixel, and wherein each subcomponent of the plurality of subcomponents corresponds to a subpixel.

17. The system of claim 11, wherein the least one microscopic light-emitting component further comprises at least one quantum dot.

18. The system of claim 17, wherein the least one microscopic light-emitting component comprises a plurality of subcomponents, and wherein the at least one quantum dot is on at least one subcomponent of the plurality of subcomponents.

19. The system of claim 11, wherein the first component is a processor component, and wherein the second component is a memory component.

20. The system of claim 19, wherein the second component is a high bandwidth memory (HBM) component.
